(19) United States
(12) Patent Application Publication
(10) Pub. No.: US 2012/0272533 A1
(43) Pub. Date: Nov. 1, 2012

(54) HAIR CLIPPER

(76) Inventors: Satoshi Sobagaki, Kyoto (JP); Hitoshi Ogawa, Shiga (JP)

(21) Appl. No.: 13/443,520

(22) Filed: Apr. 10, 2012

(30) Foreign Application Priority Data
Apr. 26, 2011 (JP) 2011-098442

(51) Int. Cl. B26B 19/06

(52) U.S. Cl. 30/201

(57) ABSTRACT

The hair clipper of the present invention includes an adjusting device configured to adjust a clipping height determined by a relative position of a second comb-like blade to a first comb-like blade. The device includes a slider configured to vary the relative position, and a handle ring, and a connection mechanism connecting the ring to the slider such that the slider is moved with rotation of the ring. The mechanism includes a cam groove and a linking pin placed inside the cam groove. The cam groove includes plural holding grooves extending in a direction across the moving direction of the slider and a connection groove connecting the holding grooves. The plural holding grooves are formed in different positions in the moving direction respectively associated with the different clipping heights. Each holding groove is configured to hold the pin between its opposite inner sides.

### TECHNICAL FIELD

The present invention relates to hair clippers, and particularly to a hair clipper with a clipping height adjusting function.

### BACKGROUND ART

In the past, there has been provided an electric hair clipper configured to cut human head hair by use of a comb-like fixed blade and a comb-like movable blade reciprocated relative to the fixed blade. The electric hair clipper includes one configured to vary a clipping height by means of attaching a specific attachment for adjusting the clipping height, and another configured to adjust the clipping height by means of sliding one of the fixed blade and the movable blade along the other in a blade end direction across a reciprocation direction and a blade thickness direction so as to vary a relative position of the fixed blade and the movable blade.

With regard to the former, the specific attachment is necessary for varying the clipping height. In contrast, the latter employs a mechanism for adjusting the clipping height by making use of the fixed blade formed into a wedge shape. Thus, the latter enables a user to adjust the clipping height finely by only changing the setting by one's hands without using such a specific attachment. The latter is mainly adopted for professional use rather than personal use.

Document 1 (JP 3412834 B) discloses a hair clipper including a handle ring attached to a main body incorporating a motor. With regard to this hair clipper, rotation of the handle ring causes a forward/rearward movement of a slider, thereby changing the position of the movable blade. As a result, the clipping height is varied. Further, according to Document 1, in order to move the slider forward/rearward with the rotation of the handle ring, the handle ring is provided at its inner surface with an inclined cam groove, and the slider is provided with a linking pin inserted into the cam groove. In this hair clipper, the inclined cam groove includes a first lengthwise side formed into a stepwise shape constructed by alternately connecting straight surfaces perpendicular to the forward/rearward direction and slope surfaces inclined relative to the forward/rearward direction. According to this hair clipper with a function of adjusting the clipping height, it is possible to stabilize the linking pin.

However, Document 1 discloses only one of the opposite lengthwise sides of the cam groove is formed into a stepwise shape and the other is entirely formed into a slope shape. In view of a movable range of the linking pin (slider) in the forward/rearward direction, only one lengthwise side includes the straight surfaces perpendicular to the forward/rearward direction. Therefore, with regard to a position for keeping the adjusted clipping height constant, the movable range of the linking pin is relatively wide. Accordingly, a vibration resulting from rotation of the motor and reciprocation of the movable blade is likely to cause a forward/rearward movement of the movable blade, and therefore cause a slight variation of the clipping height.

### DISCLOSURE OF INVENTION

In view of the above insufficiency, the present invention has been aimed to propose a hair clipper capable of facilitating adjusting a clipping height to a desired height and of keeping the adjusted clipping height constant precisely.

The hair clipper of the first aspect in accordance with the present invention includes a first comb-like blade, a second comb-like blade, a main body, a driving device, and an adjusting device. The second comb-like blade is arranged to overlap with the first comb-like blade. The main body is configured to hold the first comb-like blade and the second comb-like blade. The driving device is housed in the main body and is configured to reciprocate the second comb-like blade relative to the first comb-like blade in a lengthwise direction of the second comb-like blade. The adjusting device is configured to adjust a clipping height determined by a relative position of the second comb-like blade to the first comb-like blade in a width direction of the second comb-like blade. The adjusting device includes a slider, a handle ring, and a connection mechanism. The slider is attached to the main body so as to be moved in a predetermined moving direction, and is connected to the second comb-like blade. The handle ring is attached to the main body so as to be rotated around a rotation axis extending along the moving direction. The connection mechanism is configured to connect the handle ring to the slider such that the slider is moved with rotation of the handle ring. The connection mechanism includes a cam groove and a linking pin. The cam groove is provided to one of the slider and the handle ring, and the linking pin is provided to the other of the slider and the handle ring. The linking pin is placed inside the cam groove so as to be moved along the cam groove. The cam groove includes plural holding grooves extending in a direction across the moving direction and a connection groove configured to connect the holding grooves. The plural holding grooves are formed in different positions in the moving direction respectively associated with the different clipping heights. Each of the holding grooves is configured to hold the linking pin between its opposite inner sides.

According to the hair clipper of the second aspect of the present invention, in addition to the first aspect, the holding groove extends orthogonal to the moving direction. The holding groove has its opposite inner sides parallel to each other. A distance between the opposite inner sides of the holding groove is identical to a dimension of the linking pin in the moving direction.

According to the hair clipper of the third aspect of the present invention, in addition to the first or second aspect, the adjusting device includes a click producing mechanism configured to prevent a relative movement of the linking pin to the handle ring when the handle ring comes in a predetermined position. The predetermined position includes a first position in which the linking pin is positioned in the holding groove associated with the highest clipping height and a second position in which the linking pin is positioned in the holding groove associated with the lowest clipping height.

### BRIEF DESCRIPTION OF DRAWINGS

FIG. 1 is a front view illustrating the primary part of the hair clipper of one embodiment in accordance with the present invention,

FIG. 2 is a perspective view illustrating the above hair clipper,

FIG. 3 is a perspective view illustrating the blade block of the above hair clipper,

FIG. 4 is a cross sectional view illustrating the blade block of the above hair clipper,

FIG. 5 is a cross sectional view illustrating the blade block of the above hair clipper,

FIG. 6 is a perspective view illustrating the main body of the above hair clipper,

FIG. 7 is a perspective view illustrating the blade block and the main body of the above hair clipper,

FIG. 8 is an explanatory view illustrating the inner surface of the handle ring of the above hair clipper,

FIG. 9 is a top view illustrating the handle ring of the above hair clipper, and

FIG. 10 is a front view illustrating the primary part of the hair clipper of another embodiment in accordance with the present invention.

### BEST MODE FOR CARRYING OUT THE INVENTION

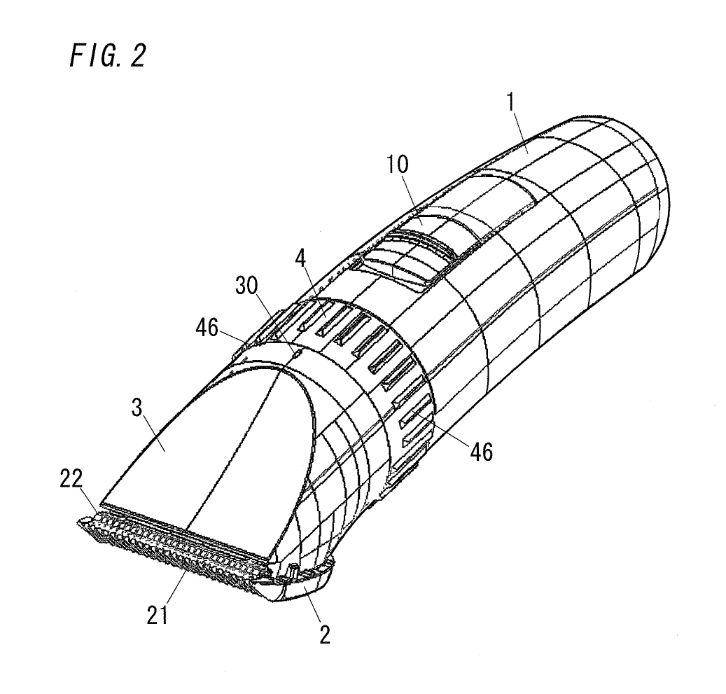

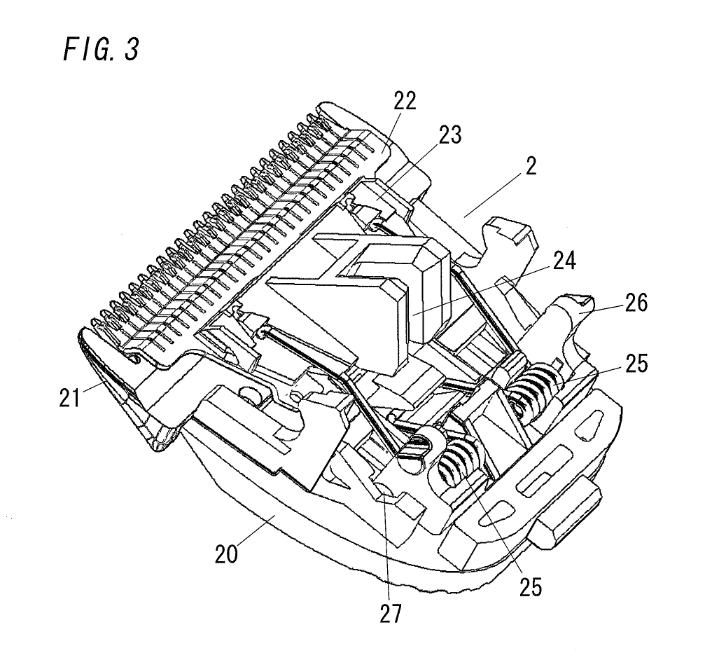

The hair clipper (electric hair clipper) of one embodiment of the present invention includes, as shown in FIG. 2, a main body 1, and a head 3. Main body 1 incorporates a motor (not shown), and is encircled by a handle ring 4. Head 3 is detachably coupled to a front end of main body 1. Head 3 includes a blade block 2. As shown in FIG. 2, main body 1 is equipped with a power switch 10.

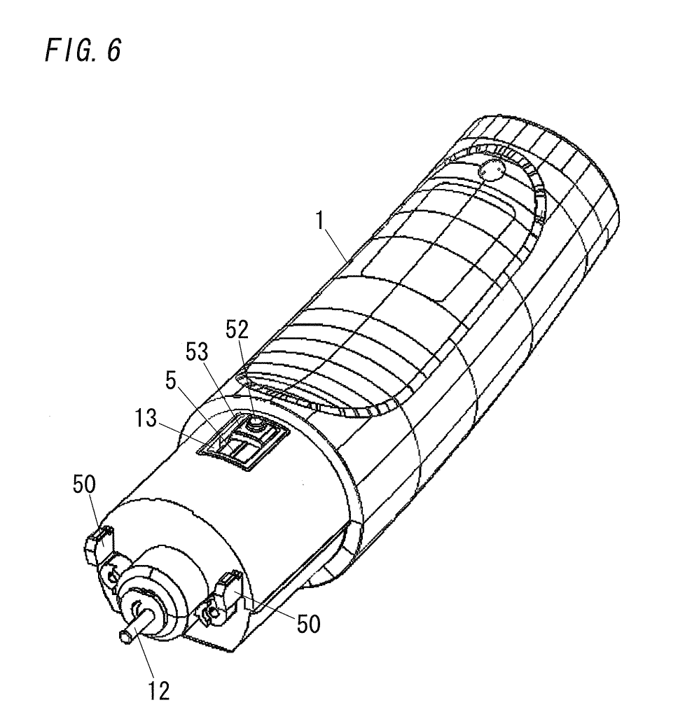

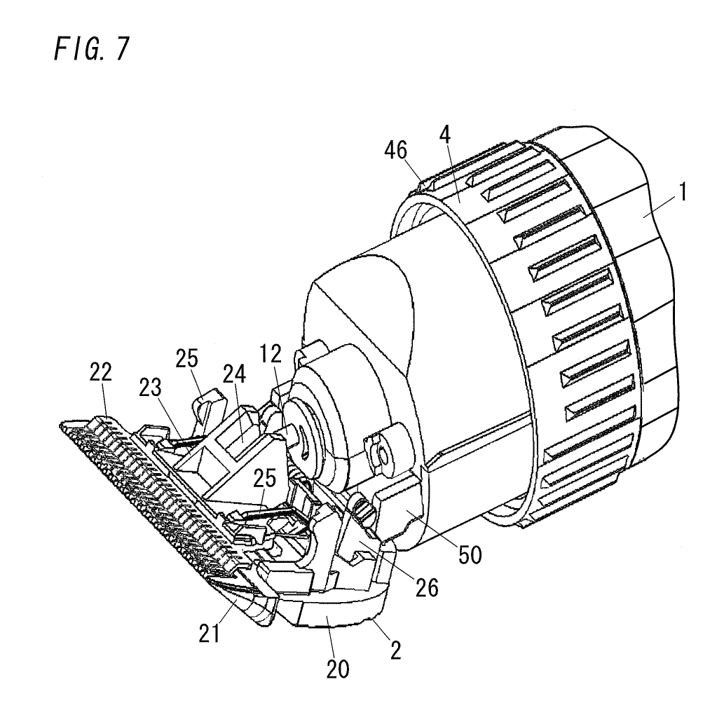

As shown in FIG. 2, blade block 2 includes a fixed blade 21 and a movable blade 22. Fixed blade 21 is fixed to an inner surface of a substrate 20. Movable blade 22 is configured to slide along fixed blade 21. Each of fixed blade 21 and movable blade 22 has its front end formed into a comb-like shape. Further, movable blade 22 is coupled to a guiding cam 23. Guiding cam 23 includes a longitudinal groove 24 designed to make engagement with an eccentric shaft 12 (see FIG. 6 and FIG. 7) fixed to an output axle of the motor inside main body 1. This engagement allows movable blade 22 to reciprocate in response to rotation of the motor.

As mentioned in the above, the hair clipper of the present embodiment includes a first comb-like blade (fixed blade 12 in the present embodiment), a second comb-like blade (movable blade 22 in the present embodiment) arranged to overlap with the first comb-like blade, and main body 1 configured to hold the first comb-like blade and the second comb-like blade. Main body 1 is configured to incorporate a driving device (the motor) configured to reciprocate the second comb-like blade relative to the first comb-like blade in a lengthwise direction of the second comb-like blade.

Further, there is a lever 26 which is coupled to substrate 20 in a rotative manner. Lever 26 is configured to be rotated around an axle 27. Lever 26 has a first end engaged with substrate 20, and a second end holding a main part of a coil spring 25 coupled to guiding cam 23. Coil spring 25 is configured to keep pressing movable blade 22 against fixed blade 21. Coil spring 25 slides movable blade 22 along fixed blade 21 in a direction orthogonal to a reciprocation direction and a thickness direction of the movable blade 22 in response to rotation of lever 26.

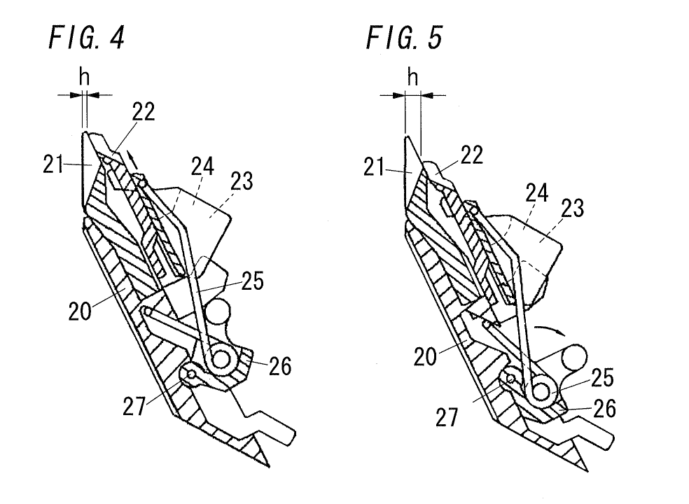

Fixed blade 21 has blades in the form of a wedge shape. As shown in FIG. 4 and FIG. 5, the clipping height “h” is decreased as movable blade 22 slides close to the front end of fixed blade 21. The clipping height “h” is increased as movable blade 22 slides away from the front end of fixed blade 21. Therefore, the clipping height (length of a remaining hair) “h” is determined by a relative position of the second comb-like blade (movable blade 22 in the present embodiment) to the first comb-like blade (fixed blade 21 in the present embodiment) in a width direction of the second comb-like blade.

Main body 1 is configured to accommodate a slider 5. Slider 5 is moved in the forward/rearward direction with rotation of handle ring 4. Slider 5 is provided with arms 50 and 50. Arms 50 protrude outwards from the front surface of main body 1. Arms 50 are in contact with lever 26 at their respective front ends. Lever 26 is biased in an arrow direction shown in FIG. 5 by coil spring (torsion coil spring) 25. Thus, the clipping height (length of a remaining hair) “h” is varied with a forward/rearward movement of slider 5. Preferably, a spring is employed for biasing slider 5 rearwards. The spring is configured to exert force equal to the force which coil spring 25 exerts to lever 26. With this arrangement, force necessary to decrease the clipping height “h” and force necessary to increase the clipping height “h” can be equal.

The following explanation is made to a mechanism (i.e., an adjusting device) for moving slider 5 in the forward/rearward direction with the rotation of handle ring 4. Slider 5 is housed in main body 1 so as to slide in the forward/rearward direction. As shown in FIG. 6, slider 5 includes a protrusion 53 and a linking pin 52. Protrusion 53 is allowed to slide within a window 13 formed in an outer surface of main body 1. Linking pin 52 protrudes from protrusion 53. Handle ring 4 is arranged outside main body 1 so as to rotate around main body 1, and is provided at its inner surface with a cam groove 40 configured to receive linking pin 52. Cam groove 40 is inclined relative to the axial direction (sliding direction) of handle ring 4 formed into a circular cylindrical shape. Therefore, when handle ring 4 is rotated around its axis, slider 5 is moved in the forward/rearward direction.

As mentioned in the above, the hair clipper of the present embodiment includes the adjusting device configured to adjust the clipping height “h”. The adjusting device includes slider 5, handle ring 4, and a connection mechanism.

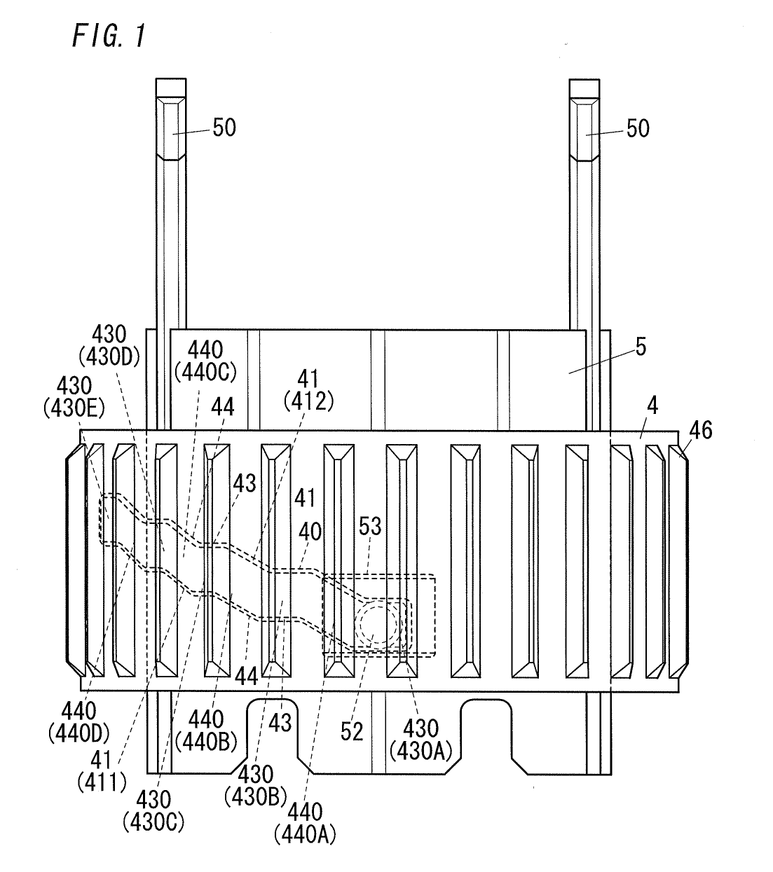

Slider 5 is attached to main body 1 so as to move in a predetermined moving direction (upward/downward direction in FIG. 1). Slider 5 includes paired arms 50 and 50, and protrusion 53. Paired arms 50 and 50 are protruded outwards from the top surface (front surface) of main body 1. Arms 50 are arranged in contact with lever 26 at their respective front ends. Thereby, slider 5 is coupled to the second comb-like blade (the movable blade 22 in the present embodiment). Protrusion 53 is positioned inside window 13 formed in the outer surface of main body 1. Linking pin 52 is formed on protrusion 53. Linking pin 52 is adapted in use to link handle ring 4 with slider 5.

Handle ring 4 is formed into a circular cylindrical shape. Handle ring 4 is attached to main body 1 so as to rotate around the rotation axis extending along the moving direction of slider 5. In the present embodiment, slider 5 is placed inside handle ring 4. Formed in the inner surface of handle ring 4 is cam groove 40. Cam groove 40 is adapted in use to link handle ring 4 with slider 5.

The connection mechanism is configured to connect handle ring 4 to slider 5 such that slider 5 moves with the rotation of handle ring 4. The connection mechanism includes cam groove 40 provided to handle ring 4, and linking pin 52 provided to slider 5. Linking pin 52 is placed inside cam groove 40 so as to move along cam groove 40. In the present embodiment, linking pin 52 is formed into a true circular shape.

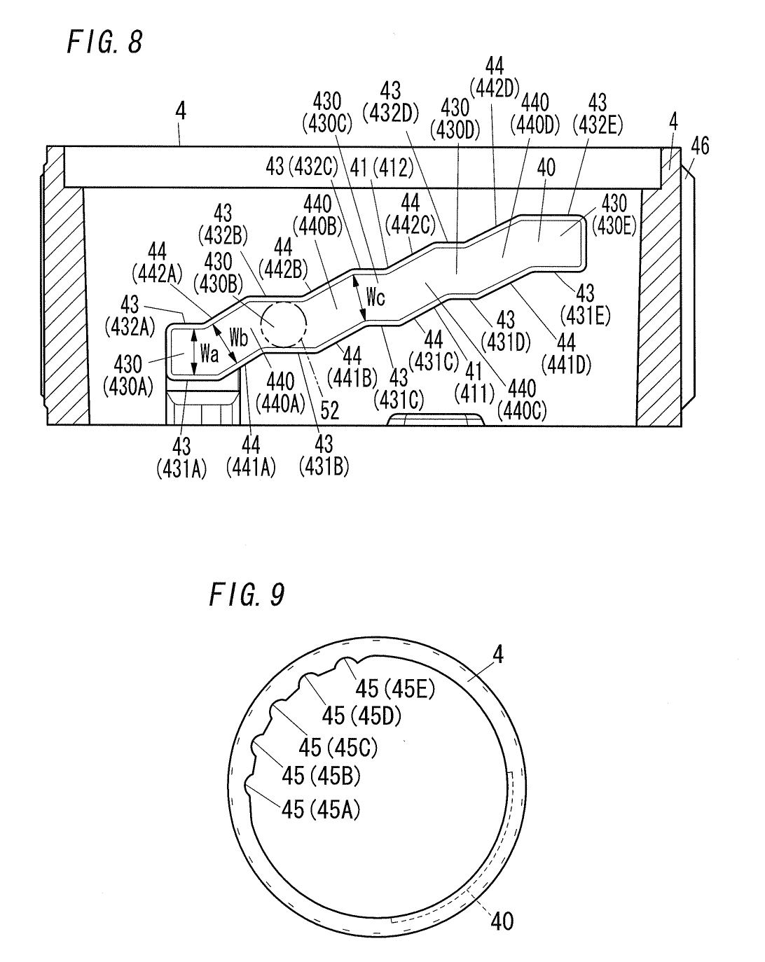

As shown in FIG. 8, cam groove 40 extends in a direction across the moving direction (upward/downward direction in FIG. 8). Cam groove 40 includes a first side 41 (411) and a second side 42 (412) which are opposite to each other in the moving direction.

First side 411 includes plural step parts 43 extending in a direction across the moving direction, and a slope part 44 configured to connect (adjacent) step parts 43 (to each other). In the present embodiment, first side 411 includes five step parts 43 (431A, 431B, 431C, 431D, and 431E) and four slope parts 44 (441A, 441B, 441C, and 441D).

Step parts 431A, 431B, 431C, 431D, and 431E are formed in different positions in the moving direction respectively associated with the different clipping heights “h”. Further, step parts 431A, 431B, 431C, 431D, and 431E are formed in different positions in a circumferential direction of handle ring 4. Step part 431A is associated with the highest clipping height “h”. Step part 431E is associated with the lowest (fifth highest) clipping height “h”. In the present embodiment, plural step parts 43 are flat surfaces orthogonal to the moving direction, and are parallel to each other.

Slope part 441A is configured to connect step part 431A to step part 431B. Slope part 441B is configured to connect step part 431B to step part 431C. Slope part 441C is configured to connect step part 431C to step part 431D. Slope part 441D is configured to connect step part 431D to step part 431E. In the present embodiment, plural slope parts 44 are flat surfaces orthogonal to the moving direction, and are parallel to each other.

Second side 412 includes plural second step parts 43 respectively opposite to plural step parts 43, and a second slope part 44 configured to connect (adjacent) step parts 43 (to each other). In the present embodiment, second side 412 includes five second step parts 43 (432A, 432B, 432C, 432D, and 432E) and four second slope parts 44 (442A, 442B, 442C, and 442D).

Second step parts 432A, 432B, 432C, 432D, and 432E are opposite to respective step parts 431A, 431B, 431C, 431D, and 431E. Second step parts 43 are parallel to respective opposite step parts 43. That is, second step parts 432A, 432B, 432C, 432D, and 432E are formed in different positions in the moving direction respectively associated with the different clipping heights “h”. Further, second step parts 432A, 432B, 432C, 432D, and 432E are formed in different positions in the circumferential direction of handle ring 4. Second step part 432A is associated with the highest clipping height “h”. Second step part 432E is associated with the lowest clipping height “h”. In the present embodiment, plural second step parts 43 are flat surfaces orthogonal to the moving direction, and are parallel to each other.

Second slope part 442A is configured to connect second step part 432A to second step part 432B. Second slope part 442B is configured to connect second step part 432B to second step part 432C. Second slope part 442C is configured to connect second step part 432C to second step part 432D. Second slope part 442D is configured to connect second step part 432D to second step part 432E. Therefore, second slope parts 442A, 442B, 442C, and 442D are opposite to respective slope parts 441A, 441B, 441C, and 441D. In the present embodiment, plural second slope parts 44 are flat surfaces orthogonal to the moving direction, and are parallel to each other.

With respect to cam groove 40, step part 43 (431A, 431B, 431C, 431D, 431E) and second step part 43 (432A, 432B, 432C, 432D, 432E) opposite to the same step part 43 constitute a holding groove 430 (430A, 430B, 430C, 430D, 430E) determining the clipping height “h”. In the present embodiment, each of step part 431 and second step part 432 is a flat surface perpendicular to the moving direction. Thus, each holding groove 430 extends orthogonal to the moving direction. In addition, each of holding grooves 430 has its opposite inner sides parallel to each other.

Further, slope part 44 (441A, 441B, 441C, 441D) and second slope part 44 (442A, 442B, 442C, 442D) opposite to the same slope part 44 constitute a connection groove 440 (440A, 440B, 440C, 440D) configured to connect (adjacent) holding grooves 430 (to each other).

Consequently, cam groove 40 is constituted by plural holding grooves 430 (430A, 430B, 430C, 430D, 430E) associated with respective different clipping heights “h” and connection grooves 440 (440A, 440B, 440C, 440D) configured to connect holding grooves 430.

Plural holding grooves 430 have the same width Wa. Width Wa of holding groove 430 is equal to a distance between step part 43 and second step part 43 opposite to the same step part 43 (a distance between the opposite sides of holding groove 430). Width Wa of holding groove 430 is defined as a width of cam groove 40 at step part 43 of first side 411 (or second step part 43 of second side 412). In the present embodiment, width Wa of holding groove 430 is identical to a dimension of linking pin 52 (diameter of linking pin 52) in the moving direction. Therefore, linking pin 52 is positioned in holding groove 430 in such a manner to be in contact with the opposite inner sides (step part 43 and second step part 43) of holding groove 430. Consequently, slider 5 is prevented from moving in the moving direction.

Plural connection grooves 440 have the same width Wb. Width Wb of connection groove 440 is equal to a distance between slope part 44 and second slope part 44 opposite to the same slope part 44. Width Wb of connection groove 440 is defined as a width of cam groove 40 at slope part 44 of first side 411 (or second slope part 44 of second side 412). In the present embodiment, width Wb of connection groove 440 is identical to the dimension of linking pin 52 (diameter of linking pin 52) in the moving direction.

With regard to cam groove 40, width Wa of holding groove 430 and width Wb of connection groove 440 are less than a width Wc of cam groove 40 at a border between holding groove 430 and connection groove 440. Width Wc of cam groove 40 at the border between holding groove 430 and connection groove 440 is defined as a distance between a border between step part 43 and slope part 44 and a border between second step part 43 and second slope part 44 respectively opposite to the same step part 43 and the same slope part 44. In other words, second side 412 is formed such that cam groove 40 has a smaller width at step part 43 than at the border between step part 43 and slope part 44. That is, second side 412 is designed such that width Wa of holding groove 430 (width of cam groove 40 at step 43) is less than width Wc of cam groove 40 at the border between holding groove 430 and connection groove 440.

Cam groove 40 includes paired lengthwise sides 41 and 41 arranged in the axial direction of handle ring 4. Lengthwise sides 41 and 41 are formed into a stepwise shape. In brief, as shown in FIG. 1 and FIG. 8, each of lengthwise sides 41 and 41 includes multiple step parts 43 and multiple slope parts 44. Step parts 43 extend approximately orthogonal to the axial direction (sliding direction of slider 5). Slope parts 44 are configured to connect in series plural (five in the illustrated instance) step parts 43 formed in the respective different positions.

Linking pin 52 is formed into a circular shape. Alternatively, linking pin 52 may be formed into an oval shape or a polygonal shape. While linking pin 52 is placed between any one of step parts 43 of one of lengthwise sides 41 of cam groove 40 and step part 43 of the other of lengthwise sides 41 of cam groove 40 which is opposite thereto in the axial direction, the adjusted clipping height “h” is kept constant. With moving linking pin 52 from the space between opposite step parts 43 and 43 to the space between the other opposite step parts 43 and 43 through the space between slope parts 44 and 44 of respective lengthwise sides 41 and 41 in the pair, the clipping height “h” is changed to the other height corresponding to the other opposite step parts 43 and 43.

While the clipping height “h” is selected, linking pin 52 is held between opposite step parts 43 and 43 in the axial direction. Therefore, in contrast to the prior art where one of lengthwise sides 41 and 41 is formed into a stepwise shape and the other is constituted by only slope parts 44 inclined relative to the axial direction (sliding direction of slider 5), it is possible to decrease gaps between slider 5 and the inner side of cam groove 4 in the sliding direction as possible. Accordingly, the adjusted clipping height “h” can be successfully kept constant.

Besides, for the purpose of allowing linking pin 52 to move within cam groove 40 and of stabilizing, as possible, linking pin 52 in the position associated with the desired clipping height “h”, interval Wc is selected greater than interval Wa between opposite step parts 43 and 43 in the axial direction. Interval Wc is defined as an interval between opposite lengthwise sides 41 and 41 in a direction orthogonal to a tangent line of linking pin 52 at an outside corner between step part 43 and slope part 44 adjacent thereto of one lengthwise side 41. The opposite interval Wb between opposite slope parts 44 and 44 may be equal to interval Wa. Interval Wb is defined as an interval between opposite lengthwise sides 41 and 41 in a direction orthogonal to a tangent line of linking pin 52 at a point where linking pin 52 is in contact with slope part 44 of one lengthwise side 41. Preferably, interval Wb is slightly greater than interval Wa. With this arrangement, it is possible to change the clipping height “h” smoothly. In other words, preferably, a gap between linking pin 52 and the inner surface (lengthwise side 41) of cam groove 40 becomes smaller at the position of determining the clipping height “h” than at the position of varying the clipping height “h”.

In the present embodiment, in order to successfully keep the adjusted clipping height “h” constant, a click producing means is provided. The click producing means is configured to produce click feeling at the position of determining the clipping height “h”. In brief, the click producing means is configured to generate click feeling when linking pin 52 comes between step parts 43 and 43.

In other words, the adjusting device includes the click producing means (click producing mechanism) configured to prevent a relative movement of linking pin 52 to handle ring 4 when handle ring 4 comes in a predetermined position. In the present embodiment, the predetermined position including a first position, a second position, a third position, a fourth position, and a fifth position. The first position is defined as a position at which linking pin 52 is positioned at step part 431A (holding groove 430A) associated with the highest clipping height “h”. The second position is defined as a position at which linking pin 52 is positioned at step part 431E (holding groove 430E) associated with the lowest clipping height “h”. The third position is defined as a position at which linking pin 52 is positioned at step part 431B (holding groove 430B) associated with the second highest clipping height “h”. The fourth position is defined as a position at which linking pin 52 is positioned at step part 431C (holding groove 430C) associated with the third highest clipping height “h”. The fifth position is defined as a position at which linking pin 52 is positioned at step part 431D (holding groove 430D) associated with the fourth highest clipping height “h”.

This click producing means includes a click protrusion (not shown) and plural (five in the illustrated instance) click recesses 45 (45A, 45B, 45C, 45D, and 45E), as shown in FIG. 9. The click protrusion is provided to the outer surface of main body 1 which is concealed by handle ring 4. The click protrusion is biased by a spring, thereby protruded from the outer surface of the main body 1. The click recesses 45 are formed in the inner surface of handle ring 4 and are arranged in the circumferential direction thereof at the same intervals. When handle ring 4 is positioned at the position of determining the clipping height “h”, the click protrusion is fitted into a corresponding one of the click recesses 45 due to a spring force. Thereby, the movement of handle ring 4 is prevented. In addition, the click protrusion is designed to come into contact with an inner surface of click recess 45 when fitted into click recess 45. In brief, when the click protrusion enters click recess 45, the click feeling is produced. In the present embodiment, click recesses 45A, 45B, 45C, 45D, and 45E are respectively corresponding to the first position, the third position, the fourth position, the fifth position, and the second position.

Besides, for the purpose of clearly indicating adjustable range of the clipping height “h”, the click producing means may be configured to produce the click feeling in response to only a condition (first position) corresponding to the highest clipping height “h” and a condition (second position) corresponding to the lowest clipping height “h”. While linking pin 52 is positioned between opposite step parts 42 and 42 of cam groove 40, the adjusted clipping height “h” is successfully kept constant. Consequently, even when the click producing means does not prevents the movement of handle ring 4 at the positions other than the end positions, an undesired change in the clipping height “h” is prevented.

Handle ring 4 is provided at its outer circumferential surface with plural elongated protrusions 46. Elongated protrusions 46 extend in the axial direction of handle ring 4 and are arranged in the circumferential direction of handle ring 4 at intervals. Elongated protrusions 46 are provided in order to facilitate manual rotation of handle ring 4. Elongated protrusions 46 are spaced at intervals corresponding to the positions of determining the clipping height “h”. Preferably, elongated protrusion 46 is positioned such that, when handle ring 4 is at the position of determining the clipping height “h”, elongated protrusion 46 and an indicator 30 provided to head 3 are aligned.

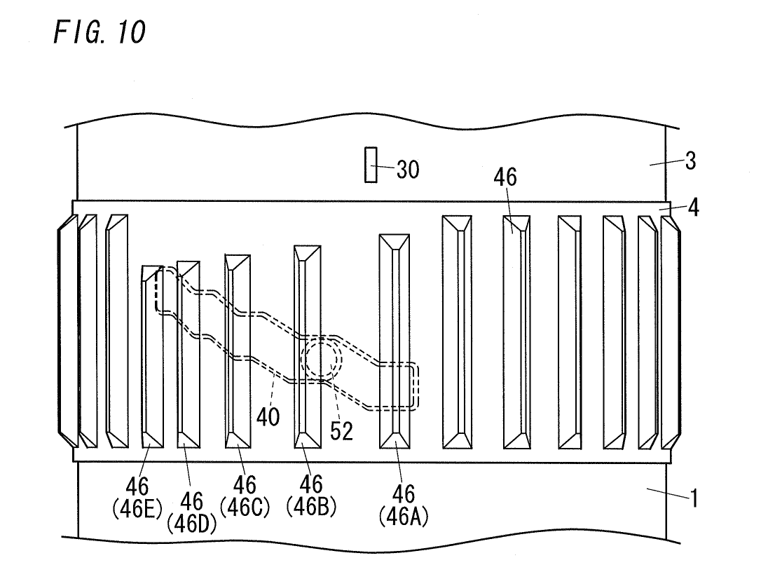

FIG. 10 illustrates an instance corresponding to the above arrangement. Especially in this instance, elongated protrusion 46 has a dimension in the axial direction corresponding to the associated clipping height “h”. In brief, when the lower clipping height “h” is selected, the indicator 30 is aligned with shorter elongated protrusion 46. When the higher clipping height “h” is selected, indicator 30 is aligned with longer elongated protrusion 46. Therefore, a user can know the present clipping height “h” by checking the length of elongated protrusion 46 provided as a finger stop.

In the instance illustrated in FIG. 10, handle ring 4 is provided at its outer surface with plural finger stops (elongated protrusions) 46. Plural finger stops 46 include finger stops 46 (46A to 46E) respectively associated with the different clipping heights “h”. Finger stop 46A is a first finger stop associated with the highest clipping height “h”. Finger stop 46E is a second finger stop associated with the lowest clipping height “h”. Finger stop 46B is a third finger stop associated with the second highest clipping height “h”. Finger stop 46C is a fourth finger stop associated with the third highest clipping height “h”. Finger stop 46D is a fifth finger stop associated with the fourth highest clipping height “h”.

Finger stop (first finger stop) 46A is positioned in the outer surface of handle ring 4 such that first finger stop 46A and indicator 30 align (in the moving direction) when handle ring 4 is positioned in the first position. Finger stop (second finger stop) 46E is positioned in the outer surface of handle ring 4 such that second finger stop 46E and indicator 30 align when handle ring 4 is positioned in the second position. Finger stop (third finger stop) 46B is positioned in the outer surface of handle ring 4 such that third finger stop 46B and indicator 30 align when handle ring 4 is positioned in the third position. Finger stop (fourth finger stop) 46C is positioned in the outer surface of handle ring 4 such that fourth finger stop 46C and indicator 30 align when handle ring 4 is positioned in the fourth position. Finger stop (fifth finger stop) 46D is positioned in the outer surface of handle ring 4 such that fifth finger stop 46D and indicator 30 align when handle ring 4 is positioned in the fifth position.

Besides, elongated protrusions 46 associated with the respective clipping heights “h” are shorter than the other elongated protrusions 46. Therefore, it is possible to keep a space for showing digits indicative of the corresponding clipping height “h” on the outer surface of the handle ring 4.

For example, when the differences in length of elongated protrusions 46 clearly show a range within which handle ring 4 is allowed to rotate for adjusting the clipping height “h”, it is unnecessary that the intervals between adjacent elongated protrusions 46 and 46 and the intervals between the adjacent positions of keeping the clipping heights “h” are equal respectively. The finger stop provided to the outer surface of handle ring 4 may be an elongated recess (groove) instead of elongated protrusion 46 shown in the illustrated instance.

In the present embodiment, linking pin 52 and cam groove 40 are provided to slider 5 and handle ring 4, respectively. Alternatively, cam groove 40 and linking pin 52 are provided to slider 5 and handle ring 4, respectively. In other words, the connection mechanism may include cam groove 40 provided to one of slider 5 and handle ring 4 and linking pin 52 provided to the other of slider 5 and handle ring 4. Further, step part 43 of cam groove 40 is not limited to a flat surface, but may be a curved surface.

In this embodiment, the clipping height “h” is adjusted by means of moving movable blade 22 in the direction orthogonal to the reciprocation direction. Alternatively, fixed blade 21 may be configured to slide along substrate 2 of blade block 2, and slider 5 may be coupled to fixed blade 21 at its arms 50. In this arrangement, the clipping height “h” is adjusted by means of moving fixed blade 21. In brief, movable blade 22 and fixed blade 21 may be used as the first comb-like blade and the second comb-like blade, respectively.

As described in the above, the hair clipper of the present embodiment includes fixed blade 21, movable blade 22, main body 1, slider 5, and handle ring 4. Fixed blade 21 is equipped with the comb-like blade. Movable blade 22 is equipped with the comb-like blade and is configured to be reciprocated. Main body 1 is designed to accommodate the driving means configured to reciprocate movable blade 22. Slider 5 used for adjusting the clipping height is configured to slide fixed blade 21 or movable blade 22 in a blade edge direction perpendicular to the reciprocation direction of movable blade 22. Handle ring 4 is configured to rotate around a direction substantially perpendicular to the sliding direction relative to main body 1. One of handle ring 4 and slider 5 is provided with cam groove 40, and the other is provided with linking pin 52 configured to be moved along cam groove 40. The hair clipper is configured to adjust the clipping height by means of sliding slider 5 in response to the movement of linking pin 52 along cam groove 40 caused by the rotation of handle ring 4. Cam groove 40 includes the opposite lengthwise sides 41 in the pair configured to obliquely cross the sliding direction of slider 5. Each of lengthwise sides 41 in the form of a stepwise shape includes plural step parts 43 and plural slope parts 44. Step parts 43 extend approximately perpendicular to the sliding direction. Slope parts 44 are configured to obliquely cross the sliding direction and are configured to connect the step parts 43. The step part 43 of one lengthwise side 41 and the step part 43 of the other lengthwise side 41 are configured to hold the linking pin 52 therebetween, thereby keeping the adjusted clipping height “h” constant.

In other words, the hair clipper of the present embodiment includes first comb-like blade (fixed blade 21 in the present embodiment), second comb-like blade (movable blade 22 in the present embodiment), main body 1, the driving device, and the adjusting device. Second comb-like blade 22 is arranged to overlap with first comb-like blade 21. Main body 1 is configured to hold first comb-like blade 21 and second comb-like blade 22. The driving device is housed in main body 1 and is configured to reciprocate second comb-like blade 22 relative to first comb-like blade 21 in the lengthwise direction of second comb-like blade 22. The adjusting device is configured to adjust the clipping height “h” determined by the relative position of second comb-like blade 22 to first comb-like blade 21 in the width direction of second comb-like blade 22. The adjusting device includes slider 5, handle ring 4, and the connection mechanism. Slider 5 is attached to main body 1 so as to be moved in the predetermined moving direction, and is connected to second comb-like blade 22. Handle ring 4 is attached to main body 1 so as to be rotated around the rotation axis extending along the moving direction. The connection mechanism is configured to connect handle ring 4 to slider 5 such that slider 5 is moved with rotation of handle ring 4. The connection mechanism includes cam groove 40 and linking pin 52. Cam groove 40 is provided to one of slider 5 and handle ring 4, and linking pin 52 is provided to the other of slider 5 and handle ring 4. Linking pin 52 is placed inside cam groove 40 so as to be moved along cam groove 40. The cam groove 40 includes plural holding grooves 430 extending in a direction across the moving direction and connection groove 440 configured to connect the holding grooves 430. The plural holding grooves 430 are formed in the different positions in the moving direction respectively associated with the different clipping heights “h”. Each of the holding grooves 430 is configured to hold the linking pin 52 between its opposite inner sides 43.

Especially, in the hair clipper of the present embodiment, the holding groove 430 extends orthogonal to the moving direction. The holding groove 430 has its opposite inner sides 43 parallel to each other. The distance between the opposite inner sides 43 of the holding groove 430 is identical to the dimension of the linking pin 52 in the moving direction.

Further, preferably, the hair clipper of the present embodiment includes the click producing means. The click producing means is configured to produce click feeling in response to the rotation of handle ring 4. The click producing means is configured to produce the click feeling in association with at least the opposite ends of the rotation range of handle ring 4 for adjusting the clipping height.

In other words, according to the hair clipper of the present embodiment, the adjusting device includes the click producing mechanism configured to prevent the relative movement of linking pin 52 to handle ring 4 when handle ring 4 comes in the predetermined position. The predetermined position includes the first position in which linking pin 52 is positioned in holding groove 430A associated with the highest clipping height “h” and the second position in which linking pin 52 is positioned in holding groove 430E associated with the lowest clipping height “h”.

According to the aforementioned hair clipper of the present embodiment, it is possible to easily vary the clipping height “h” by means of rotating handle ring 4. Further, cam groove 40 provided to one of handle ring 4 and slider 5 has its opposite lengthwise sides 41 and 41. Since each of opposite lengthwise sides 41 is formed into a stepwise shape, the movable range of linking pin 52 is narrow with regard to a position for determining the adjusted clipping height “h”. Consequently, it is possible to successfully keep the adjusted clipping height “h” constant.

1. A hair clipper comprising:
a first comb-like blade;
a second comb-like blade arranged to overlap with said first comb-like blade;
a main body configured to hold said first comb-like blade and said second comb-like blade;
a driving device housed in said main body and configured to reciprocate said second comb-like blade relative to said first comb-like blade in a lengthwise direction of said second comb-like blade; and
an adjusting device configured to adjust a clipping height determined by a relative position of said second comb-like blade to said first comb-like blade in a width direction of said second comb-like blade,
wherein said adjusting device comprises:
a slider attached to said main body so as to be moved in a predetermined moving direction, and connected to said second comb-like blade;
a handle ring attached to said main body so as to be rotated around a rotation axis extending along said moving direction; and
a connection mechanism configured to connect said handle ring to said slider such that said slider is moved with rotation of said handle ring,
said connection mechanism comprising:
a cam groove provided to one of said slider and said handle ring; and
a linking pin provided to the other of said slider and said handle ring, and placed inside said cam groove so as to be moved along said cam groove;
said cam groove including:
plural holding grooves extending in a direction across the moving direction; and
a connection groove configured to connect said holding grooves,
said plural holding grooves being formed in different positions in the moving direction respectively associated with the different clipping heights, and
each of said holding grooves being configured to hold said linking pin between its opposite inner sides.

2. A hair clipper as set forth in claim 1, wherein
said holding groove extends orthogonal to the moving direction,
said holding groove having its opposite inner sides parallel to each other, and
a distance between the opposite inner sides of said holding groove being identical to a dimension of said linking pin in the moving direction.

3. A hair clipper as set forth in claim 1, wherein
said adjusting device includes a click producing mechanism configured to prevent a relative movement of said linking pin to said handle ring when said handle ring comes in a predetermined position,
the predetermined position including a first position in which said linking pin is positioned in said holding groove associated with the highest clipping height and a second position in which said linking pin is positioned in said holding groove associated with the lowest clipping height.

4. A hair clipper as set forth in claim 2, wherein
said adjusting device includes a click producing mechanism configured to prevent a relative movement of said linking pin to said handle ring when said handle ring comes in a predetermined position,
the predetermined position including a first position in which said linking pin is positioned in said holding groove associated with the highest clipping height and a second position in which said linking pin is positioned in said holding groove associated with the lowest clipping height.
